(19) United States
(12) Patent Application Publication
(10) Pub. No.: US 2026/0080339 A1
(43) Pub. Date: Mar. 19, 2026

(54) ARTIFICIAL INTELLIGENCE-ENHANCED PERSONAL DATA MANAGEMENT PLATFORM

(71) Applicant: McEnroe Group, LLC, Greenwich, CT (US)

(72) Inventor: William McEnroe, Greenwich, CT (US)

(21) Appl. No.: 19/329,402

(22) Filed: Sep. 15, 2025

Related U.S. Application Data
(60) Provisional application No. 63/694,547, filed on Sep. 13, 2024.

(51) Int. Cl. G06Q 10/0637; G06F 40/35

(52) U.S. Cl. CPC G06Q 10/0637; G06F 40/35

(57) ABSTRACT

Methods and systems for providing online platforms that leverage artificial intelligence for managing and analyzing personal data are provided. Such platforms may provide a secure environment for users to encrypt their data for privacy, as well as aggregate and analyze personal information from multiple sources using AI algorithms and classify the data for easy access and interpretation. The platform may further enable users to generate insights and make informed decisions based on their data. The platform may include a user-friendly interface for interaction and customization. Continuous learning from user feedback and new data inputs allows for refining analysis and recommendations, enhancing personal data utilization.

### CROSS-REFERENCE TO RELATED APPLICATION

The present application claims the priority benefit of U.S. provisional patent application No. 63/694,547 filed Sep. 13, 2024, the disclosure of which is incorporated by reference herein.

### BACKGROUND OF THE INVENTION

### 1. Field of the Disclosure

The present disclosure is generally related to artificial intelligence (AI)-based enhancement of data management, particularly AI-enhanced analytics and management of personal data.

### 2. Description of the Related Art

Personal electronic devices such as mobile phones, smart watches, activity trackers, etc., provide large volumes of data that are not well utilized for the user's benefit. The data includes health and biometric data, communication data, location data, environmental data, media preferences, financial data, browsing data, etc.

Some data sources, such as communication data, can gather data from mobile contacts, calls, emails, calendar entries, etc. Similarly, health data can be collected by wearable devices or may be gathered from healthcare providers, such as via online web portals. An additional concern for this data is security, preventing unauthorized access, and preserving users' privacy.

Most methods of utilizing data for the user's benefit typically have a narrow scope, such as being targeted toward improving a user's health or finances. There is a lack of general-purpose methods of managing data to achieve lifestyle and well-being improvements based on identified trends. This, in part, is due to the lack of the ability to gather missing data and the traditional use of simple algorithms such as decision trees to execute a previously outlined behavior rather than generating customized content.

The ability to use artificial intelligence to analyze personal data, identify trends, gather additional data to confirm the identified trends, and further identify opportunities for personal improvement based on those trends may provide an opportunity for self-improvement across a broad spectrum of domains. Such improvement areas may include health, finances, employment, personal fulfillment, etc.

### SUMMARY OF THE INVENTION

Embodiments of the present invention may include a method and a non-transitory computer-readable storage medium having embodied thereon a program executable by a processor to perform a method for artificial intelligence assisted data management that includes receiving tracked data regarding a user account from a plurality of external sources, wherein the received data is aggregated into predefined categories, identifying a trend regarding the user account based on the aggregated data in a category, identifying a goal based on one or more iterative conversation with a large language model, generating a visual representation that includes the trend, a status indicator for the goal, and a personalized notification that includes a recommendation based on the goal, wherein the notification is based on iterative prompts generated by the large language model based on the trend and the goal, and dynamically updating the visual representation based on new data received from the external sources in real-time.

Embodiments of the present invention further includes a system for artificial intelligence assisted data management that includes a communication interface that communicates over a communication network to receive tracked data regarding a user account from a plurality of external sources, wherein the received data is aggregated into predefined categories, memory, and a processor that executes instructions stored in memory. The processor executes instructions to identify a trend regarding the user account based on the aggregated data in a category, identify a goal based on one or more iterative conversation with a large language model, generate a visual representation that includes the trend, a status indicator for the goal, and a personalized notification that includes a recommendation based on the goal, wherein the notification is based on iterative prompts generated by the large language model based on the trend and the goal, and dynamically update the visual representation based on new data received from the external sources in real-time.

### BRIEF DESCRIPTIONS OF THE DRAWINGS

FIG. 1 illustrates a personal improvement system, according to an embodiment.

FIG. 2 illustrates an example neural network architecture.

FIG. 3 illustrates a base module, according to an embodiment.

FIG. 4 illustrates a behavior monitoring module, according to an embodiment.

FIG. 5 illustrates a goals module, according to an embodiment.

FIG. 6 illustrates a recommendation module, according to an embodiment.

FIG. 7 illustrates an intervention module, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

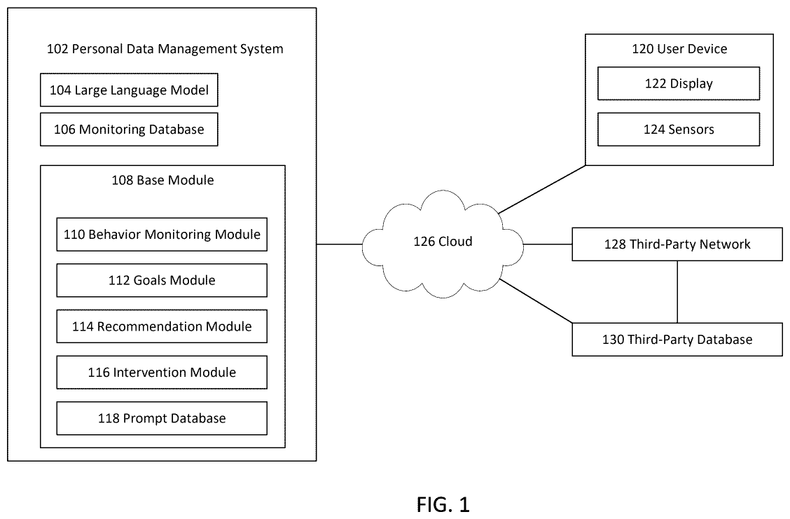

FIG. 1 illustrates a system for a personal improvement system. The system comprises a personal data management system 102, which is a system that securely collects and analyzes one or more users' data. The data may be encrypted on a local user device 120 and transmitted for storage in a third-party database 130. The personal data management system 102 may use encryption to encode data for storage and/or transmission, which may be decoded before use. Data may be stored locally or may be stored in a cloud 126. In some embodiments, the personal data management system 102 may allow a user to control access to at least part of the data managed by the system. The personal data management system 102 may be located on a user device 120, in a cloud 126, such as operating as part of a third-party network 128, or may combine local and remote processing and data storage.

A large language model 104 is a deep learning machine learning model that is pre-trained on a large amount of data and utilizes a set of neural networks that encode data into tokens. The contextual relationship between the tokens is stored in a vector database as probabilistic values, used when a prompt is provided to select the tokens to return as a response. When a prompt is received, the prompt is encoded into tokens in a process referred to as tokenization, and the tokens are used to generate a response by repeatedly predicting the next token in the response sequence. In some embodiments, the tokens may be predicted concurrently without relying on sequential processing. The tokens are then decoded into text and returned to the user. In some embodiments, a response from a large language model 104 may be used by another program, which may include another large language model 104, which may use the response as a prompt input to initiate, for example, a web search. Examples of a web search may include a search for job listings matching the parameters in the generated response. In some embodiments, a large language model 104 may operate on a third-party network 128 and be accessible via an application programming interface.

A monitoring database 106 stores data collected from sensors 124, third-party networks 128, and third-party databases 130. The monitoring database 106 may additionally store data comprising goals and relevant data indicators identified by the goals module 112, trends identified by the behavior monitoring module 110, improvement recommendations generated by the recommendation module 114, and selected improvement recommendations and related intervention statuses determined by the intervention module 116.

The base module 108 initiates the behavior monitoring module 110, which collects data via sensors 124 and from third-party databases 130 and third-party networks 128, which are used to identify trends. It is determined whether the trend is significant, and if significant, it is determined whether the trend is associated with a goal. If the trend is not significant, repeat the behavior monitoring module until a significant trend is identified. If the trend is not associated with a goal, initiate the goals module, which initiates a conversation between a user and a large language model 104 to receive interests and other relevant information to identify goals and data indicators relevant to the goals, which may improve one or more characteristics of the user or the user's quality of life. The goals and indicators are received, and the recommendation module 114 is initiated, which uses the trend data, goals, data from third-party databases 130 and third-party networks 128, and data collected via a large language model 104 conversation with the user to identify opportunities and/or improvement recommendations. The improvement recommendations are received, and the intervention module 116 is initiated, which displays the improvement recommendations to the user, which may additionally comprise notifications, alerts, instructions, recommendations, etc., to help the user progress towards at least one goal. Additional data may be received via sensors 124 to determine an intervention status, such as whether the executed improvement recommendation is positively, negatively, or negligibly influencing the trends relative to the identified goals. The intervention status is received, and if the intervention status indicates goals are achieved, and additional improvement is not necessary, end the improvement process; otherwise, initiate the behavior monitoring module 110.

The behavior monitoring module 110 is initiated by the base module 108 and initializes one or more sensors 124 used to collect data. Third-party data may additionally be acquired by querying one or more third-party databases 130 and third-party networks 128. The collected data is used to identify trends, and the collected data and identified trends are saved to the monitoring database 106 and sent to the base module 108.

The goals module 112 is initiated by the base module 108, which receives trend data, initiates a large language model 104 conversation with a user, and collects data related to the user's interests. The received data is used to identify one or more goals that may improve a characteristic of the user or the user's quality of life. Data indicators relevant to the identified goals may additionally be identified. Data may be acquired from one or more sources, including sensors 124, third-party networks 128, and third-party databases 130, to establish a data baseline, which may be saved to the monitoring database 106. The identified goals and data indicators are sent to the base module 108.

The recommendation module 114 is initiated by the base module 108 and queries the monitoring database 106 for identified trends and identifies at least one anomalous trend parameter. A third-party database 130 and/or third-party network 128 may additionally be queried to identify one or more opportunities or improvement recommendations to help remedy the anomalous trend parameters. A large language model 104 conversation may additionally be initiated with a user and conversation from the data collected to identify opportunities and improvement recommendations. The generated improvement recommendations are saved to the monitoring database 106 and are sent to the base module 108. The intervention module is initiated by the base module 108 and queries the monitoring database 106 for one or more improvement recommendations, which are displayed to the user via the display 122 on a user device 120 or via a large language model 104 conversation. The user may select one or more improvement recommendations, which are then executed. Sensor 124 data may be collected, and an intervention status may be determined based on the collected data to identify whether the executed improvement recommendation has improved the negative trend. The intervention status is saved to the monitoring database 106 and is sent to the base module 108.

The prompt database 118 stores prompts used by a large language model 104. The prompts may comprise an information component that refers to a data source, such as a monitoring database 106, third-party network 128, third-party database 130, etc. The prompts may also comprise a request component describing what the large language model 104 should return as a response. The prompts may be user-generated or generated by a large language model 104 or another artificial intelligence model. Communication with a large language model 104, such as those provided by a third-party network 128, may be achieved via an application programming interface. In other embodiments, prompts may be submitted directly to a large language model 104 hosted by a personal data management system 102.

A user device 120 may be any device a user interacts with to access a personal data management system 102. Examples of a user device 120 may include a cell phone, tablet, desktop computer, notebook computer, proprietary terminal, etc. A user device 120 may have a display 122 for displaying data and providing an interface for the user to interact with the user device 120. A display 122 is an electronic visual interface that communicates information to a user. A display 122 may include a touchscreen to facilitate interactive user input. In some embodiments, the display may include or be replaced by a speaker and microphone, which may be used to conduct verbal conversations with a large language model 104. In such embodiments, natural language processing may be used to transcribe the user's spoken language into text, which can be utilized by the large language model 104. Similarly, the large language model 104 response may be converted into audible speech and played via the speakers. Further, embodiments may include sensors 124, which detect and measure physical properties such as temperature, force, motion, pressure, heart rate, blood oxygen concentration, etc. For example, sensors 124 may include thermometers, thermocouples, bolometers, hall probes, strain gauges, load cells, accelerometers, pulse oximeters, etc. In an embodiment, a sensor 124 may comprise a pulse oximeter sensor 124 for measuring a user's heart rate and blood oxygen concentration. Another sensor may comprise an accelerometer and a global positioning system (GPS) transceiver to determine a user's location and movements. A user device 120 may communicate with the personal data management system 102 via a cloud 126.

A cloud 126 is a distributed network of computational and data storage resources that may be available via the internet or by a local network. A cloud 126 accessible via the internet is generally referred to as a public cloud, whereas a cloud 126 on a local network is generally referred to as a private cloud. A cloud 126 may be protected by encrypting data and requiring user authentication before accessing its resources. A third-party network 128 comprises one or more network resources owned by another party, which may be accessible via an application programming interface (API). For example, a third-party network 128 may refer to a financial service provider, such as a bank or credit union. A third-party network 128 may also refer to an email server, social media platform, weather service, etc. A third-party database 130 stores data owned by another party. For example, a third-party database 130 may store or access data on a third-party network 128, such as a financial service provider's database. A third-party database 130 may alternatively comprise real estate listings, vacation packages, volunteer or investment opportunities, etc.

Table 1 below illustrates the monitoring database 106. The monitoring database 106 stores data used by the personal data management system 102. The data stored may include a large language model 104 conversations with a user and data generated and used by the goals module 112, behavior monitoring module 110, recommendation module 114, and intervention module 116. The data stored may include data collected via one or more sensors 124 and data received from third-party databases 130 and/or third-party networks 128. The monitoring database 106 may store goals identified by the user, a personal data management system, and data indicators associated with each goal, representing data relevant to progress toward those goals. Additional data may include trend data identified from collected data, opportunities and/or improvement recommendations associated with the identified goals, improvement recommendations selected as interventions for negatively trending progress, and an intervention status indicating the successfulness of the interventions.

TABLE 1

| Goal | Data Indicator | Trend | Recommendation | Intervention Status |
|---|---|---|---|---|
| Maintain body weight of | Weight, Food Intake, | Increased caloric intake | Increase daily exercise | Significant |
| 180 lbs | Exercise | | | Improvement |
| Save $120k for a house | Bank Account Activity, | Increased online | Delay execution of | No Improvement |
| down payment | Credit Card Usage, | spending using credit | online transactions by 5 | |
| | Income, Loan Payments | card | minutes | |
| Earn $100k per year by | Annual Income, Job | 3% wage increase | Apply to job listing | No Improvement |
| age 30 | Opportunities | below target rate of | offering 10% salary | |
| | | increase | increase | |
| Improve blood sugar | Blood Sugar Readings, | Fluctuating levels | Replace white bread | Moderate |
| levels | Diet, Exercise | | with multigrain bread | Improvement |
| Reduce stress | Heart Rate, Blood | Increased stress levels | Apply to new job | Moderate |
| | Oxygen Concentration, | while working | | Improvement |
| | Respiration Rate, Blood | | | |
| | Pressure, Email Tone | | | |

The data collected and stored may be dependent upon the identified goals. For example, if a goal is to save money, the data stored may relate to a user's financial records and opportunities, which the user may take advantage of to improve progress toward their financial goals. Suppose the user's goal is to improve their health, such as by maintaining a body weight of 180, or to manage a health condition such as diabetes or chronic obstructive pulmonary disease (COPD). In that case, the monitoring database 106 may store health data, including but not limited to food intake, weight, exercise, blood sugar, heart rate, blood oxygen concentration, blood pressure, etc. If the user's goal were to advance their career, the data stored by the monitoring database 106 may include professional skills, experiences, and opportunities, including job listings, educational opportunities, etc. In some embodiments, career objectives may be evaluated based on one or more metrics as indicated by the user, such as salary or work fulfillment. In some embodiments, a user may seek out volunteer opportunities or may seek a balance between work and life outside work. Examples may include identifying when the user appears stressed or dissatisfied with work and identifying vacation opportunities that may be financially accessible and align with a period during which leave would likely be approved.

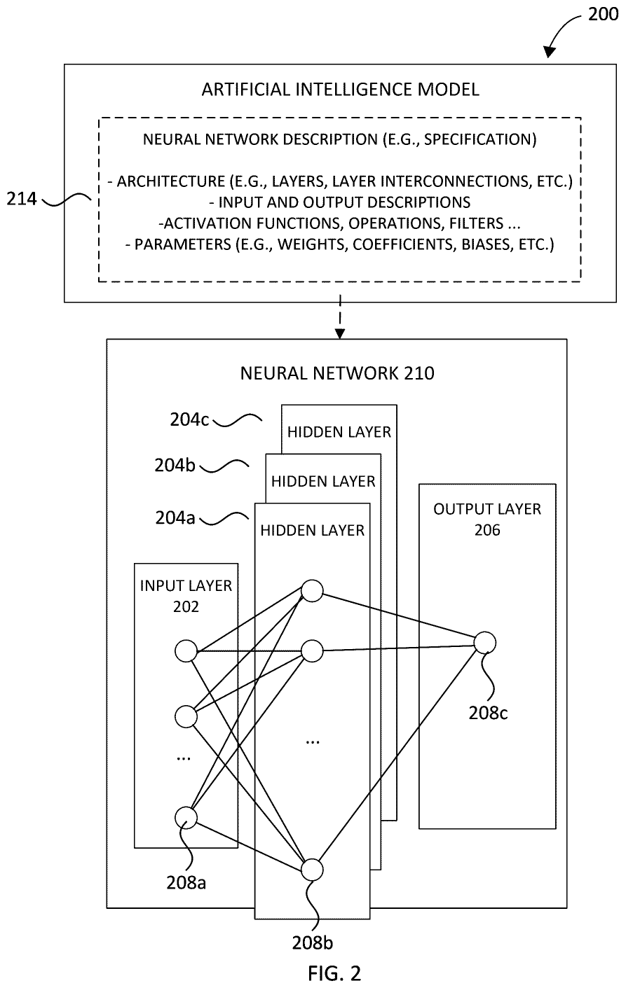

FIG. 2 illustrates an example neural network architecture that may be used to implement machine learning in relation to the AI-based processes described herein. Architecture 200 includes a neural network 210 defined by an example neural network description 214 in node 208c (neural controller). The neural network 210 can represent a neural network implementation for personal data management system 102. The neural network description 214 can include a full specification of the neural network 210, including the neural network architecture 200. For example, the neural network description 214 can include a description or specification of the architecture 200 of the neural network 210 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 210 reflects the architecture 200 defined in the input layer 202. In this example, the neural network 210 includes an input layer 202, which includes input data, such as stored historical data, stored default data, and input IMU data, user characteristics, feedback provided to the user.

The neural network 210 further includes an output layer 206 that provides an output (e.g., rendering output) resulting from the processing performed by the hidden layers 204. In one illustrative example, the output layer 206 can provide aggregated data of similar activities, similar types of users, and recommendations provided to the user. The neural network 210 in this example is a multi-layer neural network of interconnected nodes. Each node can represent a piece of information. Information associated with the nodes is shared among the different layers and each layer retains information as information is processed. In some cases, the neural network 210 can include a feed-forward neural network, in which case there are no feedback connections where outputs of the neural network are fed back into itself. In other cases, the neural network 210 can include a recurrent neural network, which can have loops that allow information to be carried across nodes while reading in input. Information can be exchanged between nodes through node-to-node interconnections between the various layers.

Nodes of the input layer 202 can activate a set of nodes in the first hidden layer 204a. For example, as shown, each of the input nodes of the input layer 202 is connected to each of the nodes of the first hidden layer 204a. The nodes of the hidden layers hidden layer 204a can transform the information of each input node by applying activation functions to the information. The information derived from the transformation can then be passed to and can activate the nodes of the next hidden layer (e.g., 204b), which can perform their own designated functions. Example functions include convolutional, up-sampling, data transformation, pooling, and/or any other suitable functions. The output of the hidden layer (e.g., 204b) can then activate nodes of the next hidden layer (e.g., 204N), and so on. The output of the last hidden layer can activate one or more nodes of the output layer 206, at which point an output is provided. In some cases, while nodes (e.g., nodes 208a, 208b, 208c) in the neural network 210 are shown as having multiple output lines, a node has a single output and all lines shown as being output from a node represent the same output value. In some cases, each node or interconnection between nodes can have a weight that is a set of parameters derived from training the neural network 210.

For example, an interconnection between nodes can represent a piece of information learned about the interconnected nodes. The interconnection can have a numeric weight that can be tuned (e.g., based on a training dataset), allowing the neural network 210 to be adaptive to inputs and able to learn as more data is processed. The neural network 210 can be pre-trained to process the features from the data in the input layer 202 using the different hidden layers 204 in order to provide the output through the output layer 206. In an example in which the neural network 210 is used to identify the machine-learning factors, the neural network 210 can be trained using training data that includes generated machine-learning factors, the stored current data, and the stored historical data including at least one of characteristics of the user, IMU data, data of similar users. For instance, training images can be input into the neural network 210, which can be processed by the neural network 210 to generate outputs which can be used to tune one or more aspects of the neural network 210, such as weights, biases, etc. In some cases, the neural network 210 can adjust weights of nodes using a training process called backpropagation. Backpropagation can include a forward pass, a loss function, a backward pass, and a weight update. The forward pass, loss function, backward pass, and parameter update is performed for one training iteration.

The process can be repeated for a certain number of iterations for each set of training data until the weights of the layers are accurately tuned. For a first training iteration for the neural network 210, the output can include values that do not give preference to any particular class due to the weights being randomly selected at initialization. With the initial weights, the neural network 210 is unable to determine low level features and thus cannot make an accurate determination of what the classification of the object might be. A loss function can be used to analyze errors in the output. Any suitable loss function definition can be used. The loss (or error) can be high for the first training dataset since the actual values will be different than the predicted output.

The goal of training is to minimize the amount of loss so that the predicted output comports with a target or ideal output. The neural network 210 can perform a backward pass by determining which inputs (weights) most contributed to the loss of the neural network 210, and can adjust the weights so that the loss decreases and is eventually minimized. A derivative of the loss with respect to the weights can be computed to determine the weights that contributed most to the loss of the neural network 210. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 210 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 210 can represent any other neural or deep learning network, such as an autoencoder, a deep belief nets (DBNs), a recurrent neural networks (RNNs), etc.

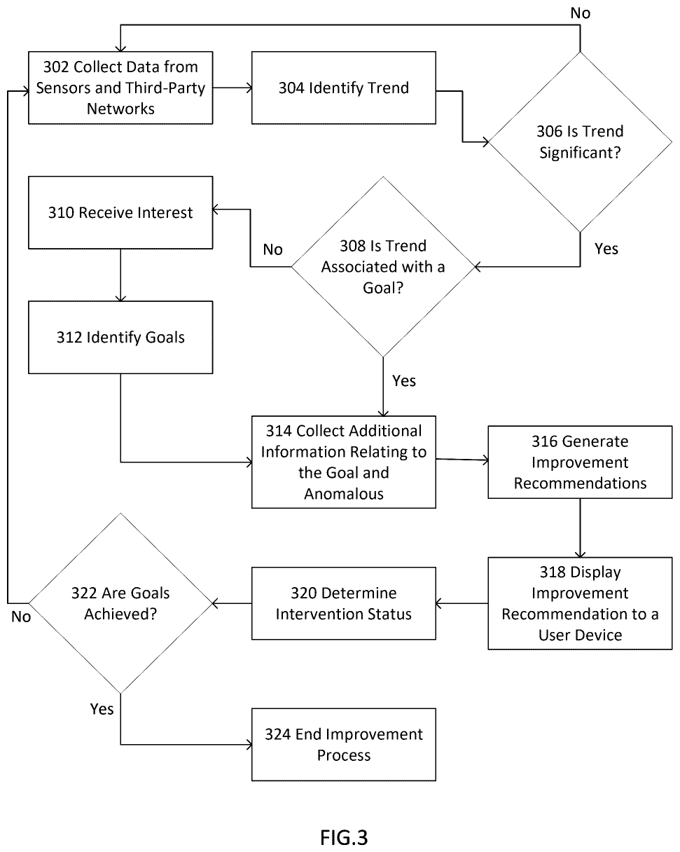

FIG. 3 illustrates the base module 108. The process begins with initiating the behavior monitoring module 110 at step 302. The behavior monitoring module 110 initializes one or more sensors 124 and collects data from the initialized sensors 124. The sensor 124 data may be relevant to one or more goals and/or data indicators relevant to one or more goals. In some embodiments, the data may not be relevant to existing goals. The behavior monitoring module 110 may query one or more third-party databases 130 and third-party networks 128 and collect third-party data relevant to one or more goals and/or data indicators relevant to one or more identified goals.

At step 304, the behavior monitoring module 110 may additionally identify trends in the data collected from the sensors 124 and the third-party networks. The data and identified trends are saved to the monitoring database 106. The identified trends may relate to one or more goals and/or data indicators relevant to one or more goals. In an embodiment, receiving an identified trend that a user's daily caloric intake has increased by 200 calories. In another embodiment, receiving a trend that the user's spending has increased. In another embodiment, receiving a trend that the user is increasingly stressed during working hours as indicated by increased heart rate, blood pressure, and sentiment in email communications.

At step 306, whether at least one trend received from the behavior monitoring module 110 is significant is determined. A significant trend is a trend with a magnitude or correlation coefficient above a threshold. For example, the threshold for significance may be 0.70. Therefore, a correlation coefficient of 0.77 would indicate a significant trend. In some embodiments, a significant correlation coefficient may be negative, such as less than −0.70. In an embodiment, a significant trend comprises the relationship between blood sugar and heart rate. In another embodiment, if the identified goal is to maintain a target weight of 180 lbs. and a target caloric intake is trending upwards at 200 calories per day above the caloric intake target, and the user's body weight is increasing at a rate of 0.05 lbs per day, the trend may be significant. In some embodiments, a trend may relate to multiple data indicators. If the trend is not significant, return to step 302 and initiate the behavior monitoring module 110 to continue collecting data and monitoring for trends. At step 308, whether a trend determined to be significant is associated with a goal is determined.

At step 310, if a significant trend is identified that is not associated with a goal, goals module 112 is initiated. In some embodiments, the goals module 112 may be initiated in response to a trigger event such as visiting a doctor's office, an opportunity that may match one or more of the user's previously identified interests, or may be initiated manually by a user. The goals module 112 initiates a conversation between the user and a large language model 104 and receives interests and other relevant information, which is then used to identify one or more goals that are relevant to the user at step 312. Data indicators are further identified as relevant to the identified goals. Baseline data may be acquired via one or more sensors 124 and/or third-party networks 128 or third-party databases 130. The baseline data may be saved to a monitoring database 106. Examples of identified goals may include maintaining a body weight of 180 lbs., managing a diagnosed health condition such as diabetes, saving money, advancing career goals, etc.

If the trend is associated with a goal, the system proceeds to step 314 and initiates the recommendation module 114. The recommendation module 114 queries the monitoring database 106 for data relating to one or more identified goals and/or data indicators associated with the identified goals and may additionally include trend data. One or more anomalous trend parameters may be identified, and a third-party database 130 and/or third-party network 128 queried for data, which may include opportunities for correcting anomalous trend parameters. A conversation between the user and a large language model 104 may be initiated to collect additional information relating to at least one goal and anomalous trend parameters, and the data collected from the conversation is used to generate at least one improvement recommendation at step 316. The improvement recommendations are saved to the monitoring database 106. In an embodiment, receiving an improvement recommendation of walking 2 miles every day to offset an increase in caloric intake to achieve the goal of maintaining a target body weight of 180 lbs. In another embodiment, the improvement recommendations may include dietary changes to improve blood sugar levels, actions that may help save money, such as refinancing loans, finding credit cards with lower interest rates, utilizing services that discourage excessive spending, or opportunities that may help reduce stress such as applying for a new job, scheduling a vacation, etc.

The intervention module 116 queries the monitoring database 106 for improvement recommendations to be displayed to a user via a user device at step 318. At least one improvement recommendation is selected and executed. Sensor 124 data is collected, and an intervention status is determined based on the executed improvement recommendation related to at least one goal at step 320. The data and intervention status are saved to the monitoring database 106. In an embodiment, an intervention status may indicate that the selected intervention has improved progress toward a goal. In another embodiment, the intervention status may indicate that the selected intervention has not improved progress toward a goal.

At step 322, the system determines whether one or more of the user's goals have been achieved. In an embodiment, a user's goal may be achieved if it is a fixed objective, such as saving money for a down payment on a house, which may be achieved when a target sum is achieved or when the user purchases a house. In other embodiments, goals may not have a defined end, such as maintaining a target body weight of 180 lbs. or reducing the variability of the user's blood sugar levels. In such embodiments, the improvement process may continue until stopped by the user. The user improvement process is terminated at step 324.

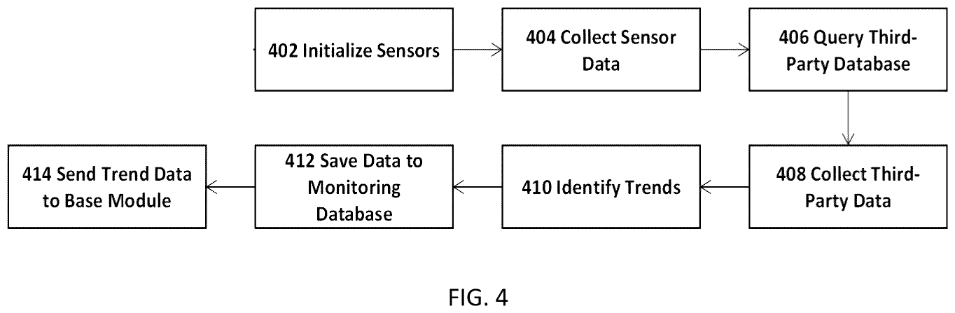

FIG. 4 illustrates the behavior monitoring module 110. The process begins with initiating the behavior monitoring module 110 by the base module 108. One or more sensors 124 related to at least one identified goal and/or data indicator are initiated at step 402. Initializing sensors 124 may include providing power to the sensors 124 and establishing communication with the sensors 124, which may include a handshake confirming that bidirectional data transfer is occurring without errors. In some embodiments, data may only be received from a sensor 124, which may not support bidirectional communication. Initializing sensors 124 may further comprise performing a calibration or acquisition of baseline data to determine that the sensor is operating within expected parameters, as may be determined based on information received from a third-party network 128 or third-party database 130, such as may be provided by the manufacturer of the sensor 124.

At step 404, sensor 124 data are collected from one or more sensors 124. In an embodiment, heart rate and blood oxygen concentration are collected from a pulse oximeter sensor 124. In another embodiment, collecting sensor 124 data from a global positioning system (GPS) sensor 124 or an accelerometer. In some embodiments, sensors 124 may comprise environmental sensors such as atmospheric pressure, temperature, humidity, air quality, etc. In an embodiment, health data such as heart rate and blood oxygen concentration can be collected from a pulse oximeter in a wearable device such as a smartwatch or health tracker. Similarly, data can be collected from a Bluetooth-enabled blood pressure monitor. In some embodiments, sensor 124 data may comprise images from a camera sensor 124, such as food consumed by a user, which may further include before and after images to allow the personal data management system 102 to use image analysis to determine an approximate number of calories consumed by the user. In some embodiments, the collected data may comprise user feedback.

At step 406, one or more third-party databases 130 are queried. In an embodiment, a third-party database 130 may comprise a database of emails, job listings, health data, property listings, financial account data, products for sale, etc., which are managed by one or more third parties such as governments, businesses, and other public and private entities. In an embodiment, a third-party network 128 may be queried via an application programming interface (API) or hypertext transfer protocol (HTTP) request. Examples of third-party networks 128 may include social media websites, e-commerce retailers, financial service systems, etc. Some third-party databases 130 and third-party networks 128 may require a secure connection in which data is encrypted, transferred to the personal data management system 102, and then decrypted to maintain data privacy and security. In some embodiments, data sent to a third-party database 130 or third-party network 128 may similarly be encrypted before sending and decrypted at its destination or stored in an encrypted state.

At step 408, third-party data from at least one third-party database 130 and/or third-party network 128 related to at least one identified goal and/or data indicator are collected. The third-party data may include emails between users and their colleagues, managers, clients, etc., or job listings, salary and/or income statements, etc., if an identified goal relates to the user's career. In other embodiments, the third-party data may relate to the user's electronic medical records and/or references relating to one or more conditions the user may have been diagnosed with or that may pose a risk based on the user's lifestyle. In other embodiments, the third-party data may comprise financial statements from a credit card provider, loan servicer, bank, credit union, etc., which may indicate the user's spending habits.

At step 410 one or more trends are identified based on the collected data from sensor 124, third-party networks and/or third party databases. In some embodiments, trends may be identified via statistical analysis. In other embodiments, trends may be identified via machine learning algorithms or an artificial intelligence model. Such models utilize correlated data to make predictions based on probabilities, which may, in a simple example, be represented by a correlation coefficient. An example of a commonly used correlation coefficient, often represented by a variable r, is the Pearson correlation coefficient, where values range from −1 to 1, with −1 representing an inverse relationship, 1 representing a positive linear relationship, and 0 representing no correlation. Pairs of data, such as time-synchronized measurements of blood sugar and heart rate, may be used to determine the correlation between blood sugar and exercise. In another embodiment, the data pairs may comprise body weight change and daily caloric intake. The Pearson correlation coefficient may be calculated using the formula r=n(Σxy−(Σx)(Σy))/√(((nΣx\hat{ }2−(Σx)\hat{ }2)(n(Σy\hat{ }2)−(Σy)\hat{ }2))) where n is the number of sample pairs, x is the first measurement, such as blood sugar measured in mg/dL, and y is the second measurement, such as heart rate measured in beats per minute.

In an example, measurements may be acquired once per minute, and n=6 measurements taken over a five-minute period include blood sugar levels of 90, 112, 85, 105, 95, and 100 and heart rate corresponding with the blood sugar levels of 60, 80, 65, 75, 70, 85. When these values are inputted into the formula, the result is a correlation coefficient of 0.77, representing a significant correlation such that as heart rate increases, blood sugar also increases. This relationship may be depicted as a line on a scatterplot of pairs of measured data where the correlation coefficient represents the slope of the line. The correlation coefficient may be used to predict the next blood sugar measurement based on an acquired heart rate. Using linear regression, the prediction model may be improved by comparing the predicted value against an actual measured value. If the predicted value of blood sugar given a heart rate of 80 is 90 mg/dL, but the measured value is 95, an offset of 5 may be applied, resulting in a shift of the line or increasing of the intercept value of the line with the axis representing blood sugar by 5.

Additional embodiments may identify trends relating to body weight relative to caloric intake or exercise as represented by heart rate. In other embodiments, trends may be identified as the relationship between the user's blood sugar and the time elapsed after eating white bread.

In some embodiments, trends may not relate to numerical data but instead may relate to text, such as via sentiment analysis. In such embodiments, the text is tokenized, and the relationship is determined based on a probabilistic distribution of the tokens representing the relative location of a first token to a second token. Through such methods, it is possible to identify trends in sentiment, such as stress or dissatisfaction with their job.

In some embodiments, collected data, including trend data, may be used to update artificial intelligence models and algorithms, including large language models 104, to improve the accuracy and effectiveness of future predictions. For example, collected blood glucose levels may represent a trend of decreasing variance, which may be used to update a large language model 104 such that recommendations to the user relating to managing their blood glucose levels may not relate to the variance of their blood glucose levels, but may instead identify other opportunities for improvement, such as managing independent blood sugar spikes based on specific foods or behaviors. Similarly, improvements in the user's spending activity may provide additional context to a large language model 104 such that recommendations to improve the user's savings may instead be oriented around identifying investment opportunities, such as recommending their savings be transferred to higher interest rate accounts.

The collected sensor 124 data and relevant third-party data are saved to the monitoring database 106 at step 412. The identified trend data may additionally be saved to the monitoring database 106. At least one identified trend is sent to the base module 108 at step 414.

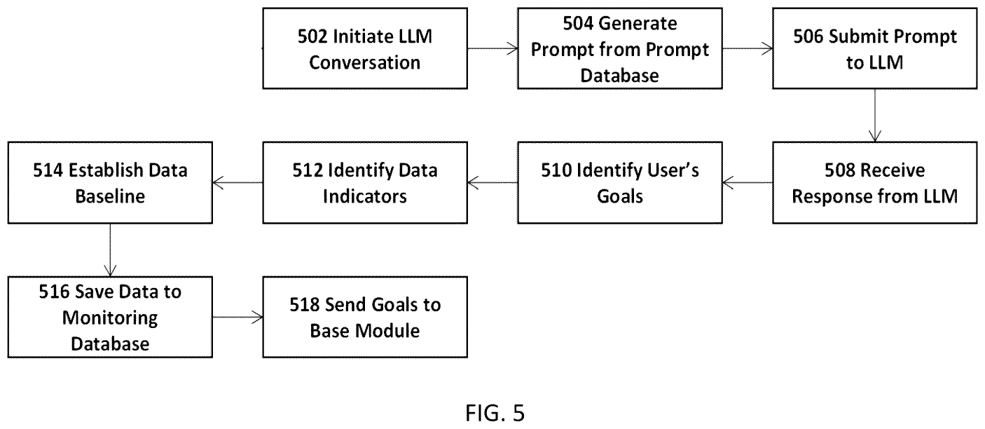

FIG. 5 illustrates the goals module 112. The process begins with initiating the goals module 112, by the base module 108. A large language model 104 initiates conversation with the user at step 502. A large language model (LLM) 104 is a generative pre-trained transformer trained on language data to operate as a context-aware chatbot. Initiating a large language model 104 conversation may comprise connecting to a large language model 104 network. In some embodiments, the connection may comprise the submission of hypertext transfer protocol (HTTP) requests via an application programming interface (API). A large language model 104 network may comprise an open-source or proprietary large language model 104. In some embodiments, a large language model 104 network may be hosted by a third-party network 128. Examples of a large language model 104 include OpenAI's ChatGPT, Google's Bard and Gemini, Microsoft's Bing, and Facebook's LLaMA. Large language models 104 may comprise monomodal or multimodal models. A monomodal model receives prompts and returns responses using the same data type, such as text. A multimodal model can receive and/or return responses using different data types such as text, speech, or other audio, images, video, etc.

At step 504, a prompt is generated from the prompt database 130. The prompt database 130 may store previously generated prompts, which may comprise a data component and a request component. The data component is structured to provide context regarding data that is provided with the request, and the request component describes the type of response to be returned by the large language model 104. In some embodiments, the large language model 104 may be fine-tuned for a specific purpose. Fine-tuning comprises further training of a pre-trained generative transformer with task-specific data, including a correct response, also known as a label. In some embodiments, prompts may be generated for different large language models 104 depending on the type of data and/or request being generated. In some embodiments, the prompts in a prompt database 130 may have been generated by a large language model 104. Some embodiments may include a [data] component of the prompt, which is a placeholder for data that may be found in a database or acquired via one or more sensors, receiving user feedback, etc. In an embodiment, a prompt may comprise an information component of “Analyze the user's blood glucose levels over the past month and determine the variance: [data].” and a request component of “Determine the variance of the user's blood glucose levels.”

At step 506, the generated prompt is submitted to the large language model 104 network. In an embodiment, the prompt may be submitted as an HTTP request via an API. In other embodiments, the large language model 104 may be integrated into a personal data management system 102, and therefore, a prompt may be submitted directly. A prompt may comprise multiple components, including a data component and a request component. A prompt may additionally comprise a system prompt, which may provide further context for the type of response to be returned. For example, a system prompt may instruct the large language model 104 to provide a text response from the perspective of a dietician, physician, career coach, financial planner, etc., to improve the accuracy of the generated responses. The prompt may be submitted in text or as speech. In some embodiments, the data component may also comprise tables, charts, figures, etc. In some embodiments, a prompt may include a request component describing the information to be returned by the large language model 104.

At step 508, a response is received from the large language model 104. The response may be in natural speech or text or include other modes such as images, data, etc. In some embodiments, the response may be received in a series of iterative prompt and response cycles such that the large language model 104 may generate an additional prompt as part of the response to receive additional information. In an embodiment, a first prompt may comprise an information component of “Analyze the user's blood glucose levels over the past month and determine the variance: [data].” and a request component of “Determine the variance of the user's blood glucose levels.” The [data] placeholder may refer to data from a database storing the user's dietary and blood glucose level data. A second prompt may similarly comprise an information component of “Consider the foods that the user has consumed which correspond to the greatest increase in blood glucose levels [data].” and a request component of “Are there substitute foods for those which correspond to increases in blood glucose levels which result in a comparatively lower increase?” in response to receiving the variance of the user's blood glucose levels and determining that the variance is above a threshold value which may be predetermined or which may be identified as high relative to training or reference data.

In another embodiment, the information component of a first prompt may be “Analyze the user's income of [data] and history of recent transactions [data] and determine the amount of essential spending including loans, rent, utilities, etc.” and the request component may be “How much of the user's income remains after essential spending?” The [data] placeholder may refer to data from a database storing the user's transaction and/or balance history, such as may belong to a credit card company or bank, or may include a source of receipts such as email receipts, manually scanned printed receipts, purchase history from one or more websites, etc. The second prompt may then comprise an information component of “Analyze the user's history of recent transactions [data] and determine the amount of discretionary spending.” and a request component of “How much of the user's spending is discretionary?”

At step 510, one or more goals that the user may wish to pursue are identified or that are identified as beneficial to the user. For example, a user may not explicitly identify health improvement as a goal, but if the user is identified as having a health condition such as diabetes, a goal to improve or manage the user's health related to the identified health condition may be identified as a goal. In other embodiments, the goals may be more directly related to information gathered from a user via the large language model 104, based on data such as a stated desire to lose weight, save money such as buying a house or a new car, take a vacation, etc. Additional examples of goals may include finding a new job, increasing earnings to $100,000 per year by age 30, etc. Goals may be identified by selecting keywords and measured data collected from the user and comparing the collected data to a database of goals and associated keyword and data metrics. In some embodiments, this process may utilize one or more machine learning algorithms such as an LLM 104 such that the data is used to generate a prompt such as “What goals have the keywords ‘diabetes,’ ‘diet,’ and daily blood glucose level measurements comprising 82 after waking up, 148 30 minutes after eating breakfast, 238 30 minutes after eating lunch, and 127 30 minutes after eating dinner?” In some embodiments, the prompt generated by the LLM 104 may be used to search a database for one or more goals matching the prompt. Identifying a user's goals may include an iterative conversation with an LLM 104. For example, a user may receive a response from an LLM 104 such as “What are your minimum requirements for a house?” or “Where do you want to live?” which may help to refine the scope of a goal. For example, saving money for a down payment for a house may comprise a specific dollar amount, such as $122,000 for a 20% down payment on a $600,000 home based on the average price of a 3-bedroom home in the user's preferred area.

At step 512, one or more indicators that may be monitored for progress towards the user's goals are identified. For example, if the user's goal is to lose weight, the indicators may include weight measurements, exercise and/or movement activity, diet, calorie consumption, nutritional content of food, intervals between consumed food, etc. If the user's goal is to improve savings, indicators may include transaction history comprising any of income statements, list of expenses, cash flow, state of investment and/or savings accounts, etc. If a user has asthma, the indicators may include air quality in the user's proximity and monitoring of the user's vital signs, including heart rate, respiration rate, blood oxygen concentration, etc. If a user expressed a career-related goal, data indicators may include email conversations, specifically the sentiment and/or topic of such communications, job listings, the user's job roles and responsibilities, etc. Data indicators may be identified based on the goal or determined based on the user's responses during a conversation with a large language model 104. For example, if the user's goal is to advance their career to make $100,000 annually by age 30, then the large language model 104 may ask the user to provide their marketable skills. In some embodiments, the large language model 104 may identify skills indirectly, such as asking the user, “What are some of your hobbies?” to which the user may respond, “Creating custom 3D printed models.” This indirectly represents the skill of computer-aided design, which is necessary for creating 3D-printed models. This may be identified via reference to a database of required skills for a particular hobby or task or by generating a prompt such as, “What skills are necessary for ‘creating custom 3D printed models’?” Similarly, a large language model 104 may generate a list of data indicators based upon an identified goal of maintaining a body weight of 180 lbs. by generating a prompt such as, “What factors can be monitored which may impact the goal of ‘maintaining a body weight of 180 lbs.’?”

At step 514, a baseline measurement of data indicators is established. Such a baseline may be established by initializing and polling one or more sensors 124 associated with the data indicator type. For example, if the data indicator comprises heart rate and blood oxygen concentration, a pulse oximeter is initialized, and the user's vital signs are monitored for a predetermined period. Alternatively, the baseline may comprise a long-term or moving average of measurements. In other embodiments, a data indicator may comprise communications with colleagues, such as via email, of which a sentiment analysis may be performed to determine the user's level of positivity, which may be based upon the relative frequency of messages sent by the user with a positive versus negative sentiment. The baseline may similarly monitor the content of conversations for the frequency of keywords or phrases such as ‘overtime,’ ‘poor performance,’ ‘burn out,’ etc. In embodiments with goals related to financial improvement, the data baseline may comprise the user's income and transaction history. In some embodiments, the data baseline may be based entirely upon previously collected data, stored in a monitoring database 106 and/or a third-party database 130 or accessed via a third-party network 128. In an embodiment, to stabilize or reduce the variance of the user's blood glucose levels, an average blood glucose level of 110 and a variance of 40 may be calculated from the user's historical blood glucose level measurements.

At step 516, the identified goals, data indicators, and collected baseline data from any of the sensors 124 and relevant third-party data are saved to the monitoring database 106. At step 516, the identified goals, data indicators, and data baselines are sent to the base module 108.

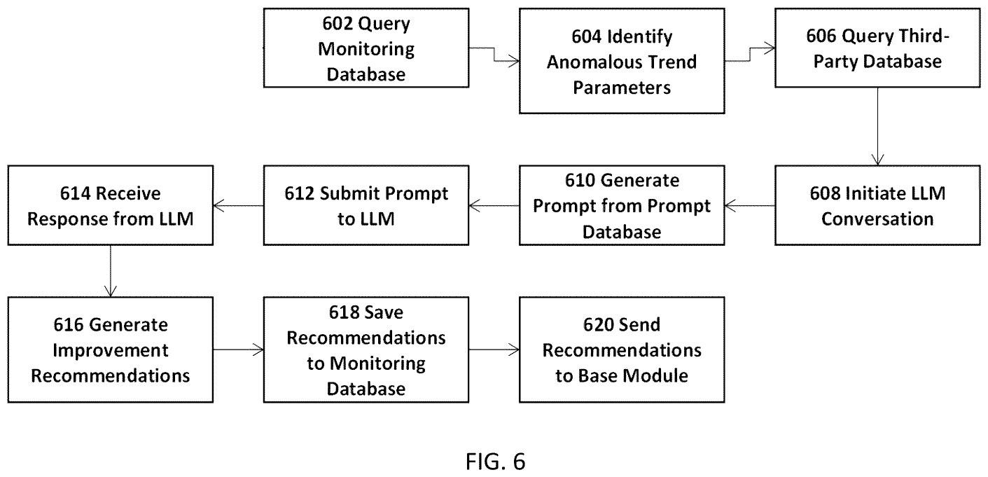

FIG. 6 illustrates the recommendation module 114. The process begins with initiating the recommendation module 114 by the base module and receiving at least one trend relating to an identified goal. At step 602, the monitoring database 106 is queried for data relating to one or more identified goals and/or data indicators associated with the identified goals. The data may additionally comprise identified trends, which may be positive or negative relative to the identified goals.

At step 604, one or more anomalous trend parameters are identified. Anomalous trend parameters may be negatively trending data indicators, such as a trending increase in caloric intake above a target caloric intake amount when an identified goal is maintaining a target weight of 180 lbs. In an embodiment, identifying that a user's caloric intake is increasing may negatively impact their goal of maintaining a weight of 180 lbs. In another embodiment, the user's spending is elevated, preventing them from saving money towards a house down payment. In another embodiment, the sentiment of a user's emails and blood pressure increase during working hours may indicate that the user is increasingly stressed at work.

At step 606, one or more third-party databases 130 are queried. In an embodiment, a third-party database 130 may comprise a database of emails, job listings, health data, property listings, financial account data, products for sale, etc., which are managed by one or more third parties such as governments, businesses, and other public and private entities. In an embodiment, a third-party network 128 may be queried, such as via an application programming interface (API) or hypertext transfer protocol (HTTP) request. Examples of third-party networks 128 may include social media websites, e-commerce retailers, financial service systems, etc. Additional examples of third-party databases 130 and third-party networks 128 include those that may be utilized to identify opportunities for improvement, which may be provided as improvement recommendations. For example, a website hosting job listings may include a job for which the user is qualified if the user's job is causing elevated stress levels or if the user's salary expectations are not being met. In another embodiment, a credit card may be available with a lower interest rate, or similarly, there are opportunities to refinance an existing loan at a lower interest rate. In other embodiments, a service may be available to delay processing purchases to allow the user to reconsider whether the purchase is necessary. In other embodiments, the third-party database 130 may comprise health data such as describing a health condition and means of correcting negative trends, such as stabilizing an elevated or fluctuating blood sugar.

At step 608, a large language model 104 conversation with the user is initiated. The large language model 104 conversation may utilize information from goals and identified anomalous trend parameters to determine the causes of a trend and identify possible improvement recommendations. Initiating a large language model 104 conversation may comprise connecting to a large language model 104 network. In some embodiments, the connection may comprise the submission of hypertext transfer protocol (HTTP) requests via an application programming interface (API). A large language model 104 network may comprise an open-source or proprietary large language model 104. In some embodiments, a large language model 104 network may be hosted by a third-party network 128. Examples of a large language model 104 include OpenAI's ChatGPT, Google's Bard and Gemini, Microsoft's Bing, and Facebook's LLaMA. Large language models 104 may comprise monomodal or multimodal models. A monomodal model receives prompts and returns responses using the same data type, such as text. A multimodal model can receive and/or return responses using different data types such as text, speech, or other audio, images, video, etc.

At step 610, a prompt from the prompt database 130 is generated. The prompt database 130 may store previously generated prompts, which may comprise a data component and a request component. The data component is structured to provide context regarding data that is provided with the request, and the request component describes the type of response to be returned by the large language model 104. In some embodiments, the large language model 104 may be fine-tuned for a specific purpose. Fine-tuning comprises further training of a pre-trained generative transformer with task-specific data, including a correct response, also known as a label. In some embodiments, prompts may be generated for different large language models 104 depending on the type of data and/or request being generated. In some embodiments, the prompts in a prompt database 130 may have been generated by a large language model 104. Some embodiments may include a [data] component of the prompt, which is a placeholder for data that may be found in a database or acquired via one or more sensors, receiving user feedback, etc. In an embodiment, a prompt may comprise an information component of “If the variance of the user's blood glucose level has not improved over the past month, consider the impact of the user's diet over the past month on blood glucose levels [data].” and a request component of “Which foods have the user consumed which have correlated to the greatest increases or variance in blood glucose levels?”

At step 612, the generated prompt is submitted to the large language model 104 network. In an embodiment, the prompt may be submitted as an HTTP request via an API. In other embodiments, the large language model 104 may be integrated into a personal data management system 102, and therefore, a prompt may be submitted directly. A prompt may comprise multiple components, including a data component and a request component. A prompt may additionally comprise a system prompt, which may provide further context for the type of response to be returned. For example, a system prompt may instruct the large language model 104 to provide a text response from the perspective of a dietician, physician, career coach, financial planner, etc., to improve the accuracy of the generated responses. The prompt may be submitted in text or as speech. In some embodiments, the data component may also comprise tables, charts, figures, etc. In some embodiments, a prompt may include a request component describing the information to be returned by the large language model 104.

At step 614, a response is received from the large language model 104. The response may be in natural speech or text or include other modes such as images, data, etc. In some embodiments, the response may be received in a series of iterative prompt and response cycles such that the large language model 104 may generate an additional prompt as part of the response to receive additional information. In an embodiment, a first prompt may comprise an information component of “If the variance of the user's blood glucose level has not improved over the past month, consider the impact of the user's diet over the past month on blood glucose levels [data].” and a request component of “Which foods have the user consumed which have correlated to the greatest increases or variance in blood glucose levels?” The [data] placeholder may refer to data from a database storing the user's dietary and blood glucose level data. A second prompt may similarly comprise an information component of “Consider the foods that the user has consumed which correspond to the greatest increase in blood glucose levels [data] Consider the foods that the user has consumed which correspond to the greatest increase in blood glucose levels [data].” and a request component of “Are there substitute foods for those which correspond to increases in blood glucose levels which result in a comparatively lower increase?” in response to receiving the foods consumed by the user which were correlated to an increase in the user's blood glucose levels. In another embodiment, the information component of a first prompt may be “Consider the amount of savings of [data] that the user has, the monthly contribution of [data], and the user's discretionary spending of [data].” and the request component may be “How long would it take the user to save enough to purchase a $400,000 home at the current rate of saving versus if the user maximized their savings by using their discretionary spending?” The [data] placeholder may refer to data from a database storing the user's transaction and/or balance history, such as belonging to a credit card company or bank, and income, such as from a payment provider.

At step 616 one or more improvement recommendations are generated. Recommendations may be generated via a machine learning algorithm or artificial intelligence model, using data collected from a goal, data indicators, trend data, sensors 124, one or more third-party databases 130 or third-party networks 128, or conversation data. For example, if a goal is to reduce the volatility of the user's blood sugar levels, and a trend is identified such that heart rate and blood oxygen levels are significantly correlated and based on the trend data, generating an improvement recommendation to maintain a heart rate between 80 and 95 beats per minute which should reduce the amount of variation in blood sugar levels. Similarly, trends may be identified for blood sugar relative to the elapsed time since consumption of different foods, and an improvement recommendation comprises dietary recommendations based on the foods that have a minimal impact on the user's blood sugar levels. For example, foods high in protein like peanut butter and whole grain bread may have a lower glycemic index than white bread, therefore recommending peanut butter and/or whole grain bread as a snack instead of white bread. In other embodiments, an improvement recommendation may comprise walking two miles each day in response to an identified significant trend of increased body weight at a rate of 0.05 lbs. per day as the user's daily caloric intake has increased by approximately 200 calories for a goal of maintaining a body weight of 180 lbs. In other embodiments, an identified trend may comprise increased stress during working hours, an identified goal may be to reduce stress, and the generated improvement recommendation may be to submit an application for a new job, a listing of which may be provided to a user. In some embodiments, the personal data management system 102 may automatically submit a job application with an updated copy of the user's resume to the job. In some embodiments, notifications and/or alerts may be sent to the user via a user device 120 to receive confirmation of an improvement recommendation. For example, if a user's goal is to save money towards a down payment on a house, and an identified trend is increased spending by the user, an improvement recommendation may comprise sending a notification to the user or requiring additional steps, such as a delay of five minutes, when the user attempts to make an online purchase. The additional steps are intended to cause the user to reconsider whether the purchase is necessary and may prompt the user to transfer the purchase amount into a savings account.

At step 618, the generated improvement recommendations are saved to the monitoring database 106. At step 620, the generated improvement recommendations are sent to the monitoring database 106.

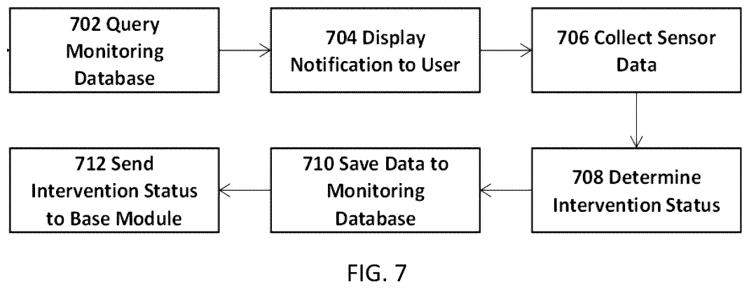

FIG. 7 illustrates the intervention module 116. The process begins with initiating the intervention module 116 by the base module, and receiving at least one goal and improvement recommendation. At step 702, the monitoring database 106 is initiated for improvement recommendations related to one or more goals.

At step 704, a notification, alert, or data relating to a goal and improvement recommendation are displayed to a user. In an embodiment, a notification may be sent to a user prompting them to either move, to increase their heart rate, or to rest, to lower their heart rate, to satisfy the improvement recommendation of maintaining a heart rate between 80 and 95 beats per minute to reduce the variability of the user's blood oxygen concentration. Alternatively, food recommendations may be displayed to the user via a display 122 of a user device 120, such as recommending peanut butter and whole grain bread instead of white bread to reduce the variability of the user's blood oxygen concentration. In another embodiment, the user may be sent alerts prompting them to walk to encourage the user to walk at least an additional two miles as an improvement recommendation in response to an identified trend of increased caloric intake. In another embodiment, a job opportunity may be displayed to the user in response to a goal to reduce stress and an identified trend of increased stress, which may be identified by increased blood pressure during working hours and negative sentiment identified in email communications. In some embodiments, the personal data management system 102 may automatically populate a job application and prompt the user to confirm whether to submit the application. In another embodiment, a user may receive a notification when attempting to make an online purchase asking the user if the purchase is necessary, which may additionally prevent the user from completing the purchase for five minutes to discourage the user from completing the purchase, and instead may recommend that the user transfer the purchase amount to a savings account. The notification, alert, or data may be displayed to the user via the display 122 of a user device 120 and/or presented to the user via a large language model 104 conversation.

The user may provide inputs via the large language module 104 or user device 120, such as to set a reminder, to take a suggested action, or to otherwise modify an improvement recommendation or goal. In some embodiments, the notifications may be displayed on an adaptive user interface. The user interface may change in response to the user's interests, goals, objectives, etc. Examples of changes may include the position or location of an element representing an interest, goal, objective, task, etc., on the user interface, size and/or shape of the elements, etc. The notifications may be comprised of text or a transformation of an element representing an interest, goal, objective, task, etc. For example, if a user's goal is to maintain their body weight and exercise, including walking 30 minutes each day has been identified as a task to help achieve that goal, then as more time passes without the user making progress towards that goal, a circle representing the task of walking for 30 minutes may change from green in the morning, to yellow, and eventually red by evening to indicate to the user the importance or urgency of completing the task soon. For example, if the task is to apply for a job, the color may advance from green to red over a week. Similarly, if the task is to schedule a vacation, the color may be related to the time that has passed since the opportunity was identified, time before a deadline, such as the expiration of an offer, or based upon data such as hotel or ticket availability. In some embodiments, the shapes may vary, such as representing a categorization of tasks based on the type of goal. For example, a financial goal may comprise triangle-shaped elements. The shapes may additionally comprise labels, icons, logos, etc., to indicate the task they represent. In some embodiments, the elements may additionally indicate progress towards a goal, such as time or distance walked, the current day or seven-day trend variance of the user's blood glucose levels, progress towards a savings goal, etc.

At step 706, data from one or more sensors 124 are collected. The sensor 124 data is acquired to determine whether data indicator trends improve in response to the executed improvement recommendation. In some embodiments, one or more third-party networks 128 and third-party databases 130 may be queried. In some embodiments, the collected data may include user feedback data. Determining at step 708, an intervention status based upon the collected sensor 124 data. The intervention status may additionally be based on collected user feedback. The collected data and user feedback are used to refine and adjust the artificial intelligence algorithms, such as the large language model 104, to determine whether the recommended interventions are effective and to improve future intervention recommendations. In some embodiments, the intervention status may indicate whether the changes made by the user and/or the personal data management system 102 have impacted progress towards the goal, indicating a lack of compliance with the selected improvement recommendation. For example, if a user reported improved outcomes from fewer blood glucose level increases, which may have previously led to increased mood swings, thirst, and urination. Similarly, the user feedback may comprise feedback from the user's physician noting an improvement in overall health, which may be used to tune the large language model 104 by reinforcing that the previous recommendations are effective. In other embodiments, the feedback may be that the user is dissatisfied with the spending cutbacks, such as specifically regarding a streaming service that provides most of the user's entertainment. The large language model 104 may utilize that feedback to change its recommendations for prioritizing savings such that some lower-cost entertainment options for the user may be included in the specific user's necessary expenditures instead of unnecessary spending. In some embodiments the user may have goals that are sorted into short and long term that the system can order into a to-do list. For example, if the user was making dinner that involves cooking a steak, steaming broccoli, and baking potatoes, the user needs to start the potatoes before they begin working on the broccoli. Similarly, longer term to-do lists can be prioritized, such as goals surrounding a user's career. For example, the user may have a goal of becoming a becoming a graphic designer, but currently lack the qualifications for the type of job they want. The system may suggest applying for jobs outside of graphic design at companies that have large graphic design departments. This would enable the user to work towards the qualifications they need while developing connections at the company. In some embodiments, to-do list style recommendations may not remain static. For example, scheduling their annual appointment may be 10^{th} on user's to-do list on a given day, but after it has been ignored for some amount of time, it may move higher on the user's to-do list. Similarly, the order of the to-do list may remain static, while the presentation of the list changes to communicate to the user. For example, the system may display a gold star next to goals that have been completed, or highlight goals that have not been addressed in a timely manner. In some embodiments, the user may be able to filter their to-do list. For example, the user may have an overall to-do list that includes health related goals, career goals, social goals, etc. They would be able to select subsets of their to-do list, such as displaying only the health related goals, or only the short term goals or only the long term goals. In some embodiments, the system may interact directly with the user's calendar to prompt scheduling related to goals, such as doctor's appointments or calling your mother. Saving at step 710, the sensor 124 data and intervention status to the monitoring database 106. Sending at step 712, the intervention status to the base module 108. In some embodiments, multiple intervention statuses may be sent, such as if multiple improvement recommendations were selected or if the improvement recommendations are related to multiple goals.

Table 2 below illustrates the prompt database 118. The prompt database 118 stores prompts used by a large language model 104. The prompts may comprise an information component that refers to a data source, such as a monitoring database 106, third-party network 128, third-party database 130, etc. The prompts may also comprise a request component describing what the large language model 104 should return as a response. The prompts may be user-generated or generated by a large language model 104 or another artificial intelligence model. Communication with a large language model 104, such as those provided by a third-party network 128, may be achieved via an application programming interface. In other embodiments, prompts may be submitted directly to a large language model 104 hosted by a personal data management system 102. The prompt database 118 may be populated manually by a user or by a large language model 104. The prompts in the prompt database 118 may be updated by a large language model 104 using data collected by the behavior monitoring module 110 and the intervention module 116. The prompt database 118 is used by the goals module 112 and the recommendation module 114.

TABLE 2

| Module | Category | Information Component | Data Source | Request Component |
|---|---|---|---|---|
| Goal | Career | Consider the user's work and | LinkedIn | Provide a list of jobs the user may be |
| | | education experience from [data]. | | qualified for. |
| Recommendation | Career | Identify the salary for the identified | LinkedIn, | Provide a list of jobs with a salary |
| | | jobs [data], and for those without a | Glassdoor | above $100,000. |
| | | salary, obtain a corresponding salary | | |
| | | from [data]. | | |
| Goal | Blood | Analyze the user's blood glucose levels | Blood | Determine the variance of the user's |
| | Glucose | over the past month and determine the | Glucose | blood glucose levels. |
| | | variance: [data]. | Database | |
| Goal | Blood | Compare the variance of the user's | Blood | Has the variance of the user's blood |
| | Glucose | blood glucose level from the current | Glucose | glucose level improved over the past |
| | | month to the 12 previous months using | Database | month? |
| | | [data]. | | |
| Recommendation | Blood | If the variance of the user's blood | Dietary | Which foods have the user consumed |
| | Glucose | glucose level has not improved over | Database, | which have correlated to the greatest |
| | | the past month, consider the impact of | Blood | increases or variance in blood |
| | | the user's diet over the past month on | Glucose | glucose levels? |
| | | blood glucose levels [data]. | Database | |
| Recommendation | Blood | Consider the foods that the user has | Dietary | Are there substitute foods for those |
| | Glucose | consumed which correspond to the | Database, | which correspond to increases in |
| | | greatest increase in blood glucose | Blood | blood glucose levels which result in a |
| | | levels [data]. | Glucose | comparatively lower increase? |
| | | | Database | |
| Goal | Finance | Analyze the user's income of [data] | Credit | How much of the user's income |
| | | and history of recent transactions | Card, Bank | remains after essential spending? |
| | | [data] and determine the amount of | Account, | |
| | | essential spending including loans, | Income | |
| | | rent, utilities, etc. | Statement | |
| Goal | Finance | Analyze the user's history of recent | Credit | How much of the user's spending is |
| | | transactions [data] and determine the | Card, Bank | discretionary? |
| | | amount of discretionary spending. | Account, | |
| | | | Email | |
| | | | Receipts | |
| Recommendation | Finance | Consider the amount of savings of | Credit | How long would it take the user to |
| | | [data] that the user has, the monthly | Card, Bank | save enough to purchase a $400,000 |
| | | contribution of [data], and the user's | Account, | home at the current rate of saving |
| | | discretionary spending of [data]. | Income | versus if the user maximized their |
| | | | Statement | savings by using their discretionary |
| | | | | spending? |

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A method for artificial intelligence (AI)-based personal data management, the method comprising:
receiving tracked data regarding a user account from a plurality of external sources over a communication network;
identifying a trend regarding the user account based on one or more sets of the tracked data, each set including data that has been aggregated in accordance with a predefined category;
identifying a goal based on one or more iterative conversations with a large language model;
generating a visual representation that includes the identified trend and a personalized notification based on the goal, wherein the personalized notification is generated based on iterative prompts generated by the large language model in accordance with the identified and the goal; and
dynamically updating the visual representation based on new data received from one or more of the external sources in real-time.

2. The method of claim 1, further comprising updating the large language model based on the new data.

3. The method of claim 1, further comprising identifying data indicators to be monitored based on the goal.

4. The method of claim 3, wherein identifying the data indicator is further based on sentiment analysis.

5. The method of claim 1, wherein identifying the trend is further based on sentiment analysis of user data as expressed in text in relation to the goal, and wherein the text is tokenized.

6. The method of claim 1, wherein identifying the trend is further based on time-synchronized measurements of pairs of data.

7. The method of claim 1, wherein the iterative prompts include an information component and a request component.

8. The method of claim 1, further comprising identifying one or more anomalous trend parameters that are negatively correlated with the goal.

9. The method of claim 8, further comprising determining a cause of the identified anomalous trend parameters, and updating the personalized notification based on the determined cause.

10. The method of claim 1, further comprising updating the personalized notification based on a change in variance in the trend, and triggering a different recommendation to include in the personalized notification when the change is a decrease in the variance.

11. A system for artificial intelligence assisted personal data management, the system comprising:
a communication interface that communicates over a communication network to receive tracked data regarding a user account from a plurality of external sources over a communication network;
a processor that executes instructions stored in memory, wherein the processor executes instructions to:
identify a trend regarding the user account based on one or more sets of the tracked data, each set including data that has been aggregated in accordance with a predefined category;
identify a goal based on one or more iterative conversations with a large language model;
generate a visual representation that includes the identified trend and a personalized notification based on the goal, wherein the personalized notification is generated based on iterative prompts generated by the large language model in accordance with the trend and the goal; and
dynamically update the visual representation based on new data received from one or more of the external sources in real-time.

12. The system of claim 11, wherein the processor executes further instructions to update the large language model based on the new data.

13. The system of claim 11, wherein the processor executes further instructions to identify data indicators to be monitored based on the goal.

14. The system of claim 13, wherein the processor identifies the data indicators further based on sentiment analysis.

15. The system of claim 11, wherein the processor identifies the trend further based on sentiment analysis of user data as expressed in text in relation to the goal, and wherein the text is tokenized.

16. The system of claim 11, wherein the processor identifies the trend further based on time-synchronized measurements of pairs of data.

17. The system of claim 11, wherein the iterative prompts include an information component and a request component.

18. The system of claim 11, wherein the processor executes further instructions to identify one or more anomalous trend parameters that are negatively correlated with the goal.

19. The system of claim 11, wherein the processor executes further instructions to update the personalized notification based on a change in variance in the trend, and to trigger a different recommendation to include in the personalized recommendation when the change is a decrease in the variance.

20. A non-transitory, computer-readable storage medium, having embodied thereon a program executable by a processor to perform a method for artificial intelligence assisted personal data management, the method comprising:
receiving tracked data regarding a user account from a plurality of external sources over a communication network;
identifying a trend regarding the user account based on one or more sets of the tracked data, each set including data that has been aggregated in accordance with a predefined category;
identifying a goal based on one or more iterative conversations with a large language model;
generating a visual representation that includes the identified trend and a personalized notification based on the goal, wherein the notification is generated based on iterative prompts generated by the large language model in accordance with the trend and the goal; and
dynamically updating the visual representation based on new data received from one or more of the external sources in real-time.
